(19) United States
(12) Patent Application Publication
(10) Pub. No.: US 2023/0247751 A1
(43) Pub. Date: Aug. 3, 2023

(54) MICROWAVE PLASMA APPARATUS AND METHODS FOR PROCESSING FEED MATERIAL UTIZILING MULTIPLE MICROWAVE PLASMA APPLICATORS

(71) Applicant: 6K Inc., North Andover, MA (US)

(72) Inventors: Michael C. Kozlowski, Reading, MA (US); John Colwell, Durham, NH (US); Richard K. Holman, Wellesley, MA (US); Saurabh Ullal, Hollis, NH (US)

(21) Appl. No.: 18/159,643

(22) Filed: Jan. 25, 2023

Related U.S. Application Data
(60) Provisional application No. 63/267,470, filed on Feb. 2, 2022.

(51) Int. Cl. H05H 1/30; C23C 4/134

(52) U.S. Cl. CPC H05H 1/30; C23C 4/134; H05H 1/02

(57) ABSTRACT

The embodiments disclosed herein are directed to systems and devices which utilize multiple microwave plasmas can be used to increase the efficiency of traditional single microwave plasma systems. Disclosed herein is a microwave plasma apparatus for processing materials which includes a reaction chamber, a plurality of microwave plasma applicators in communication with the reaction chamber, one or more microwave radiation sources, at least one waveguide for guiding microwave radiation from the one or more microwave radiations sources to multiple plasma applicators, and a material feeding system in communication with the reaction chamber.

### INCORPORATION BY REFERENCE TO ANY PRIORITY APPLICATIONS

This application claims the priority benefit under 35 U.S.C. § 119(e) of U.S. Provisional Application No. 63/267,470, filed Feb. 2, 2022, the entire disclosure of which is incorporated herein by reference in its entirety. Any and all applications for which a foreign or domestic priority claim is identified in the Application Data Sheet as filed with the present application are hereby incorporated by reference under 37 CFR 1.57.

### BACKGROUND

### Field

The present disclosure is generally directed towards microwave plasma apparatuses that utilize multiple microwave plasma applicators within a single apparatus for processing feed material within a reaction chamber.

### Description

Plasma torches generate and provide high temperature directed flows of plasma for a variety of purposes. The two main types of plasma torches are induction plasma torches and microwave plasma torches. Generally, inductive plasmas suffer from plasma non-uniformity. This non-uniformity leads to limitations on the ability of inductive plasmas to process certain materials. Furthermore, significant differences exist between the microwave plasma apparatuses described herein and other plasma generation torches, such as induction plasma. For example, microwave plasma is hotter on the interior of the plasma plume, while induction is hotter on the outside of the plumes. In particular, the outer region of an induction plasma can reach about 10,000 K while the inside processing region may only reach about 1,000 K. This large temperature difference leads to material processing and feeding problems. Furthermore, induction plasma apparatuses are unable to process feedstocks at low enough temperatures to avoid melting of certain feed materials without extinguishing the plasma. Thus, microwave plasma methods and systems described herein may overcome the problems with existing in inductive plasma systems.

Conventional microwave plasma torch systems use a singular microwave plasma applicator to generate a microwave plasma. Materials are usually introduced from above the plasma applicators or at one or more openings below the applicators alongside the produced plasma. These materials may be used in a variety of applications, including, for example, additive manufacturing and battery technologies.

In a conventional single applicator microwave torch, a plasma may be formed from one applicator by superheating and ionizing a plasma gas, and then directing the plasma gas downward into a reaction chamber in which a feedstock material is provided to the plasma and processed into a material. Conventional systems for using a single applicator for material processing create about 40 kW of power embodied in the plasma gas. While offering a significant amount of power, at higher feedstock throughputs, the amount of power of the single microwave plasma will be saturated. These high temperature plasmas may, for example, enable processing of a variety of materials that are exposed to or fed into the plasma. One such type of processing is taking one or more materials of a particular size and shape and, after exposing or feeding it into the plasma, process or transform the one or more materials into a different size or shape. However, these plasma systems can be used to specifically tailor a variety of specific material properties.

Because of the need to better tailor end-product material properties and the inherent limitations on single applicator microwave plasma efficiency, there exists a need for improved microwave plasma apparatuses and processes.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Some embodiments herein are directed to a microwave plasma apparatus for processing a material, the microwave plasma apparatus comprising: a reaction chamber; a plurality of microwave plasma applicators in communication with the reaction chamber; at least one microwave radiation source for generating microwave radiation; at least one waveguide configured to direct the microwave radiation from the at least one microwave radiation source to the plurality of microwave plasma applicators; and a material feeding system in communication with the reaction chamber.

In some embodiments, each microwave plasma applicator of the plurality of microwave plasma applicators is configured to generate a plasma plume. In some embodiments, the plurality of microwave plasma applicators are arranged such that the plasma plume generated by each microwave plasma applicator converges to form a combined plasma plume. In some embodiments, each of the plurality of microwave plasma applicators is substantially parallel to a central axis. In some embodiments, each of the plurality of microwave plasma applicators are angled towards a central axis; and an angle between each of the plurality of microwave plasma applicators and the central axis is between 0°-90°.

In some embodiments, the apparatus further comprises at least one gas supply system in communication with at least one microwave plasma applicator of the plurality of microwave plasma applicators. In some of the embodiments, the at least one microwave plasma applicator is configured to generate at least one plasma plume when a gas is introduced to the at least one microwave plasma applicator from the at least one gas supply system.

In some embodiments, the microwave plasma apparatus comprises the same number of microwave radiation sources and the same number of waveguides as the number of microwave plasma applicators. In some embodiments, the microwave plasma apparatus comprises half the number of microwave radiation sources as the number of microwave plasma applicators. In some embodiments, the microwave plasma apparatus comprises half the number of waveguides as the number of microwave plasma applicators.

In some embodiments, the plurality of microwave plasma applicators comprises two to four microwave plasma applicators. In some embodiments, the plurality of microwave plasma applicators are arranged in a planar geometry relative to one another. In some embodiments, the plurality of microwave plasma applicators consists of three microwave plasma applicators. In some embodiments, each of the three microwave plasma applicators is planarly disposed relative to at least one other microwave plasma applicator at an angle of 120°. In some embodiments, the plurality of microwave plasma applicators consists of four microwave plasma applicators. In some embodiments, each of the four microwave plasma applicators is planarly disposed relative to at least one other microwave plasma applicator of the plurality of microwave plasma applicators at an angle of 90°. In some embodiments, the plurality of microwave plasma applicators comprises 2, 3, or 4 microwave plasma applicators. In some embodiments, each of the 2, 3, or 4 microwave plasma applicators is planarly disposed relative to at least one other microwave plasma applicator at an angle of about 90°, about 120°, or about 180°. In some embodiments, the plurality of microwave plasma applicators are arranged in a planar geometry relative to one another. In some embodiments, the plurality of microwave plasma applicators consists of 2 microwave plasma applicators. In some embodiments, the plurality of microwave plasma applicators consists of 4 microwave plasma applicators. In some embodiments, each of the four microwave plasma applicators is planarly disposed relative to at least one other microwave plasma applicator of the plurality of microwave plasma applicators at an angle of 90°.

In some embodiments, the material feeding system is configured to feed a process material between the plurality of microwave plasma applicators. In some embodiments, the reaction chamber includes an outlet; and wherein the material feeding system is configured to feed a process material to the reaction chamber from a location above the outlet. In some embodiments, the reaction chamber includes an outlet; and wherein the material feeding system is configured to direct a process material to the reaction chamber from a horizontal direction below the outlet. In some embodiments, the apparatus further comprises an extension tube within the reaction chamber configured to confine a plasma generated by each of the plurality of microwave plasma applicators.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates an exemplary single applicator microwave plasma system.

FIGS. 2A-B illustrate an exemplary single applicator microwave plasma system that includes a side feeding hopper.

FIG. 3 illustrates an exemplary single applicator microwave plasma system.

FIG. 4 illustrates an exemplary multiple applicator microwave plasma system with two plasma applicators.

FIG. 5 illustrates an exemplary multiple applicator microwave plasma system with three plasma applicators.

FIG. 6 illustrates an exemplary multiple applicator microwave plasma system with four plasma applicators.

FIG. 7 illustrates another embodiment of a multiple applicator microwave plasma system with four plasma applicators.

FIG. 8 illustrates another embodiment of a multiple applicator microwave plasma system with four plasma applicators.

FIG. 9 illustrates an embodiment of a downstream portion of a multiple applicator microwave plasma system including an extension tube.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto or as presented in the future is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

While single microwave plasmas can offer a significant amount of power, at higher feedstock throughputs, the amount of power of a single microwave plasma will be saturated. In some embodiments, to increase feedstock throughput, possible efficiency improvements can be made by increasing the number and arrangement of plasma applicators within the torch system. Increasing the number of plasma applicators in a single processing zone can increase the amount of power within the plasma without other changes to device subsystems. Therefore, by using multiple plasma torches, higher system efficiency can be achieved.

Single applicator plasma torch systems generally function by using a singular plasma applicator to create a singular directed plasma in which a chemical and/or physical reaction with a feed material occurs. Various parameters (e.g., power, residence time, feed material size, plasma gas type, etc.) may be adjusted to process specific materials in specific ways depending on the desired result. One drawback of single applicator microwave plasma source torches is the uneven temperature gradient of the produced plasma. This uneven gradient, along with other process limitations (e.g., power saturation, plasma size, etc.) may reduce the ability of a single applicator microwave plasma torch to control specific material synthesis parameters thereby reducing the efficiency of a microwave plasma system. To overcome these limitations, in some embodiments, plasma torches utilizing multiple microwave plasma applicators may be useful. In some embodiments, multiple applicators within the same torch may produce one or more plasmas with a more uniform temperature gradient, increased power, and/or more tunable size which may increase overall process control. In some embodiments, various and different geometric configurations of multiple plasma applicators may provide, for example, a more uniform temperature profile within the generated plasma and reaction space.

One advantage of using multiple plasma applicators in the same torch is that the design allows for axial injection of materials. In some embodiments, axial injection of materials allows for the use of a piezoelectric droplet maker which can produce highly uniform droplet sizes. In some embodiments, a highly uniform temperature gradient and high-power microwave plumes can produce a highly uniform melt state which in turn can produce highly homogenous coatings and powders compared to related technologies.

In some embodiments, using multiple applicators in the same plasma torch enables the microwave plasma apparatus to provide plasma jet temperatures as high as 8000 K, nearly twice the highest known attainable stoichiometric combustion temperature (i.e., 3000 K for hydrogen-oxygen flame). Thus, certain embodiments herein can achieve thorough heating of a material at higher velocity and larger particle sizes in a smaller distance than can be attained using a single plasma oxy-fuel torch.

Disclosed herein are embodiments of devices, assemblies, and apparatuses of microwave plasma systems using multiple microwave plasma applicators. As disclosed herein, multiple microwave plasma systems can include systems with multiple microwave plasma applicators. In some embodiments, multiple plasma systems may be used to process materials by introducing those materials into one or more of the microwave plasmas generated by multiple plasma applicators, one or more plasma plumes of the multiple plasma applicators, and/or one or more exhausts of the microwave plasma applicators. The feed location may vary depending on the desired material processing conditions, as the feed location may affect the residence time and heat exposure of the feedstock and the latency period of the feedstock within one or more of the plasmas, plumes, and/or exhausts.

Some embodiments herein are directed to microwave plasma torches with multiple microwave plasma applicators. In some embodiments, the microwave plasma applicators are planarly disposed relative to one another. In some embodiments, there may be 2, 3, 4, 5, 6, 7, 8, 9, 10, 15, 20, 25, 30, 35, 40, 45, 50, 100, 200, 300, 400, 500, or up to 1000 (or any number between the aforementioned numbers) microwave plasma applicators, each of which are planarly disposed relative to one another. In some embodiments, the multiple microwave plasma applicators are planarly and/or symmetrically arranged around a central axis. In some embodiments, each plasma applicator is disposed relative to the other plasma applicators at an angle of 180°, 150°, 130°, 120°, 90°, 72°, 60°, 45°, 30°, 20°, 15°, 10°, 5°, and/or any value between the aforementioned values.

In some embodiments, a gas supply system may be provided in communication with one or more plasma applicators of the plurality of plasma applicators. In some embodiments, multiple gas supply systems may be provided, wherein each gas supply system is connected to one of the multiple plasma applicators. In some embodiments, each of the multiple plasma applicators is configured to generate a plasma and/or plasma plume when a gas is introduced from a gas supply system. In some embodiments the gas of the gas supply system is hydrogen and/or oxygen gas. In other embodiments the gas supplied is neon, argon, helium, or other inert and/or noble gases. In other embodiments, a reactive plasma gas may be used. In some embodiments, methane gas or other hydrocarbon has may be used. In some embodiments, nitrogen gas may be used.

In some embodiments, each microwave plasma applicator is configured to generate a microwave plasma plume. In some embodiments, each plasma applicator generates a plasma plume that extends in a substantially parallel direction relative to each of the generated plasma plumes from each of the other plasma applicators. In some embodiments, the multiple microwave plasma plumes do not converge. In some embodiments, the non-convergence of the microwave plasma plumes may lead to a more uniform temperature gradient between, around, above, and/or underneath the multiple plasma plumes.

Some embodiments herein are directed at microwave plasma apparatuses with multiple microwave applicators. In some embodiments, the microwave plasma applicators are tilted away from one another, such that the plasmas generated by each individual microwave plasma applicator do not converge. In some embodiments the microwave plasma applicators are tilted towards one another, such that the plasmas generated by each individual microwave plasma applicator converge into a single plasma plume.

In some embodiments, the microwave plasma applicators are configured to surround a central axis. In some embodiments, the microwave plasma applicators are parallel to the central axis. In other embodiments, the microwave plasma applicators are tilted towards the central axis. In some embodiments, tilting the microwave plasma applicators towards the central axis causes the plasmas generated by the microwave plasma applicators to be directed towards the central axis and/or generate plasmas that converge at the central axis. In some embodiments, the angle between the plasma applicators and the central axis is 5°, 10°, 15°, 20°, 30°, 40°, 50°, 60°, 70°, 80°, or another value between 0° and 90°. In some embodiments, tilting the microwave plasma applicators in relation to a central axis causes the multiple plasma applicators to generate microwave plasma plumes which overlap at or near the central axis. In some embodiments, when multiple microwave plasmas overlap, they may converge into a single plasma. In some embodiments, a converged single plasma has desirable characteristics such as a more uniform temperature gradient and greater power relative to a microwave plasma generated from a singular microwave plasma applicator.

In some embodiments, the microwave plasma applicators generate one or more plasma plumes. In some embodiments, the microwave plasma applicators generate microwave plasma plumes in a parallel direction. In some embodiments, the parallel microwave plasma plumes overlap, and may form a single converged plasma plume. In other embodiments, the parallel microwave plasma plumes do not overlap. In some embodiments, overlapping plasmas overlap and converge into a singular, converged or combined, plasma plume. A converged or combined plasma plume may be advantageous as such a combination may result in a larger, more powerful, and more homogenous plasma. Such larger plasmas can allow for a faster throughput of feed material at a higher efficiency, leading to reduced processing cost and time.

In some embodiments, each microwave plasma applicator is connected to an individual waveguide, such that the number of waveguides and the number of microwave plasma applicators is the same. In some embodiments, each waveguide guides microwave radiation from a microwave radiation source to a plasma applicator. In some embodiments each waveguide is connected to more than one microwave plasma applicator. In some embodiments, each waveguide is connected to a single microwave plasma applicator.

In some embodiments, the microwave radiation is generated by one or more microwave generation sources. In some embodiments, one microwave power generation source provides microwave radiation to one of the multiple plasma applicators. In other embodiments, one microwave power generation source provides microwave radiation to two or more of the multiple plasma applicators. In some embodiments, one microwave power generation source provides microwave radiation to all of the plasma applicators.

In some embodiments, each microwave radiation generation source is connected to an individual waveguide, which provides the microwave radiation generated to a microwave plasma applicator. In other embodiments, one microwave radiation generation source is connected to two or more waveguides, wherein each waveguide provides microwave radiation to one of one or more microwave plasma applicators.

In some embodiments, the microwave source generates frequencies between about five hundred megahertz (500 MHz) and about one hundred gigahertz (100 GHz). In some embodiments, the nominal generator rating of the microwave source is about 915 MHz, although the generator rating is not limited to such values. In some embodiments, the output power of a microwave source is about 5 kW to about 75 kW, although the output power is not limited to such values.

Some embodiments herein are directed at a microwave plasma apparatus for processing a material. In some embodiments, the apparatus comprises a reaction chamber. In some embodiments, the reaction chamber is in communication with a plurality of plasma applicators. In some embodiments, the apparatus comprises at least one waveguide for guiding microwave radiation from at least one microwave radiation source to the plurality of plasma applicators. In some embodiments, a gas supply is in fluid communication with the plurality of plasma applicators. In some embodiments, the gas supply is configured to provide at least one gas to each plasma applicator of the plurality of plasma applicators, wherein each plasma applicator is configured to generate a plasma plume when the at least one gas is provided. In some embodiments, a material feeding system is in communication with the reaction chamber and the material feeding system is configured to direct a process material into the reaction chamber.

In some embodiments, the microwave plasma apparatus is configured for modular assembly. In some embodiments, one or more microwave plasma applicators can be added or removed to the plasma apparatus. In some embodiments, one or more of the microwave plasma applicators may be removed between reaction processes. Such modular construction can add flexibility to the use and application of a microwave plasma system.

In some embodiments, a gas injector is in communication with each plasma applicator. In some embodiments, the gas injector causes each plasma plume to flow substantially parallel to an axis of a plasma chamber, such as a central axis. In some embodiments, the use of a gas injector causes the generated plasma from each of the generated microwave plasma applicators to not converge. In other embodiments, the use of a gas injector can help cause the convergence of the multiple generated plasmas.

Some embodiments herein are directed to extending a microwave plasma generated by a microwave plasma applicator within a microwave plasma torch. In some embodiments, extending the microwave plasma may comprise obtaining a plasma of sufficient length to process feedstocks to produce materials with desired material characteristics. In some embodiments, a microwave plasma apparatus according to the embodiments herein may comprise an extension tube that extends downward into a reaction chamber of the microwave plasma apparatus, the extension tube confining and directing the microwave plasma to extend its length. In some embodiments, the extension tube may concentrate the energy and power provided by the multiple plasma applicators, in order to form a longer microwave plasma or plasmas within the apparatus. In some embodiments, the extension tube may lead to increased tailoring of materials due to the concentration of the energy and power of the multiple plasma applicators.

In a conventional microwave plasma apparatus, a plasma may be formed by superheating and ionizing a plasma gas, and then directing the plasma downward into a reaction chamber, in which a feedstock material is provided to the plasma and processed into a material. The length of a plasma, plasma plume, or plasma exhaust in a conventional microwave plasma apparatus may be limited. For example, as the plasma extends downward in a reaction chamber away from the microwave plasma applicator, the plasma is cooled by surrounding gases, such that free electrons in the plasma recombine with the plasma gas atoms, causing the plasma to end. Furthermore, as the plasma extends further from the power source, insufficient energy is provided to the plasma gas, causing the plasma to recombine into gas. Additionally, because the superheated plasma is less dense than the surrounding gases, the plasma naturally rises above the surrounding gases, which limits the length of plasma within the apparatus. Furthermore, in a conventional apparatus, the generated plasma may have length and shape that is extremely dynamic, as plasma does not generally maintain a fixed shape or volume.

To counteract these limitations in plasma length and stability, the apparatuses described herein may utilize an extension tube, which extends downward from a plurality of microwave plasma applicators into the reaction chamber. In some embodiments, the extension tube may concentrate energy from the microwave plasma applicators into a smaller volume, extending and directing the plasmas at a greater length than would be possible using a conventional microwave plasma apparatus. In some embodiments, a length of multiple plasmas may be tuned or altered by configuring one or more of the following parameters: power, plasma gas flow, type of gas, extension tube material, level of insulation of the reactor chamber or the extension tube, level of coating of extension tube, and geometry of the extension tube (e.g., tapered/stepped).

In some embodiments, an extension tube as described herein may extend downward into the reaction chamber of a microwave plasma apparatus. In some embodiments, the extension tube may extend downward at a length of at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 95%, or at least 100% of the reaction chamber length, or any value between the aforementioned values.

In some embodiments, the reaction chamber may further comprise an outlet. In some embodiments, the outlet can be configured to be below the plurality of microwave plasma applicators. In some embodiments, the outlet can surround the multiple or combined plasmas or plasmas. In some embodiments, the plasma plumes of the multiple plasma applicators can extend past the outlet. In some embodiments, a material feeding system is configured to feed material from above the outlet. In other embodiments, a material feeding system is configured to feed material from below the outlet.

### Microwave Plasma Apparatus

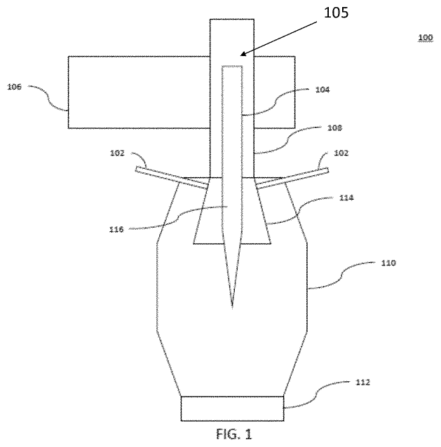

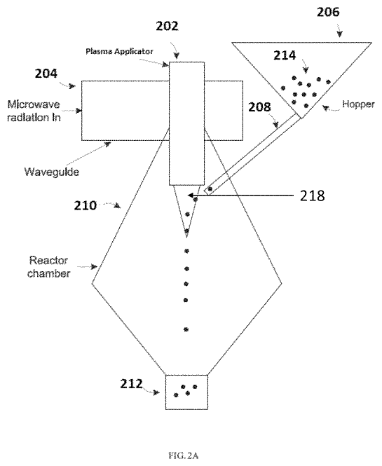

FIG. 1 illustrates an embodiment of a microwave plasma torch 100 that can be used in the production of materials according to some embodiments herein. In some embodiments, a feedstock can be introduced, via one or more feedstock inlets 102, into a microwave plasma 104. In some embodiments, an entrainment gas flow and/or a sheath flow may be injected into the microwave plasma applicator 105 to create flow conditions within the plasma applicator prior to ignition of the plasma 104 via microwave radiation source 106. In some embodiments, the entrainment flow and sheath flow are both axis-symmetric and laminar, while in other embodiments the gas flows are swirling. In some embodiments, the feedstock may be introduced into the microwave plasma torch 100, where the feedstock may be entrained by a gas flow that directs the materials toward the plasma 104.

As discussed above, the gas flows can comprise a noble gas column of the periodic table, such as helium, neon, argon, etc. Although the gases described above may be used, it is to be understood that a variety of gases can be used depending on the desired material and processing conditions. In some embodiments, within the microwave plasma 104, the feedstock may undergo a physical and/or chemical transformation. Inlets 102 can be used to introduce process gases to entrain and accelerate the feedstock towards plasma 104. In some embodiments, a second gas flow can be created to provide sheathing for the inside wall of a plasma applicator 104 and a reaction chamber 110 to protect those structures from melting due to heat radiation from plasma 104.

Various parameters of the microwave plasma 104, as created by the plasma applicator 105, may be adjusted manually or automatically in order to achieve a desired material. These parameters may include, for example, power, plasma gas flow rates, type of plasma gas, presence of an extension tube, extension tube material, level of insulation of the reactor chamber or the extension tube, level of coating of the extension tube, geometry of the extension tube (e.g. tapered/stepped), feed material size, feed material insertion rate, feed material inlet location, feed material inlet orientation, number of feed material inlets, plasma temperature, residence time and cooling rates. The resulting material may exit the plasma into a sealed chamber 112 where the material is quenched then collected.

In some embodiments, the feedstock is injected after the microwave plasma applicator for processing in the “plume” or “exhaust” of the microwave plasma torch. Thus, the plasma of the microwave plasma torch is engaged at the exit end of the plasma torch core tube 108, or further downstream. In some embodiments, adjustable downstream feeding allows engaging the feedstock with the plasma plume downstream at a temperature suitable for optimal melting of feedstock through precise targeting of temperature level and residence time. Adjusting the inlet location and plasma characteristics may allow for further customization of material characteristics. Furthermore, in some embodiments, by adjusting power, gas flow rates, pressure, and equipment configuration (e.g., introducing an extension tube), the length of the plasma plume may be adjusted.

In some embodiments, feeding configurations may include one or more individual feeding nozzles surrounding the plasma plume. The feedstock may enter the plasma from any direction and can be fed in 360° around the plasma depending on the placement and orientation of the inlets 102. Furthermore, the feedstock may enter the plasma at a specific position along the length of the plasma 104 by adjusting placement of the inlets 102, where a specific temperature has been measured and a residence time estimated for providing the desirable characteristics of the resulting material.

In some embodiments, the angle of the inlets 102 relative to the plasma 104 may be adjusted, such that the feedstock can be injected at any angle relative to the plasma 104. For example, the inlets 102 may be adjusted, such that the feedstock may be injected into the plasma at an angle of about 0 degrees, about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees relative to the direction of the plasma 104, or between any of the aforementioned values.

In some embodiments, implementation of the downstream injection method may use a downstream swirl or quenching. A downstream swirl refers to an additional swirl component that can be introduced downstream from the plasma applicator to keep the powder from the walls of the applicator 105, the reactor chamber 110, and/or an extension tube 114.

In some embodiments, the length of a reaction chamber 110 of a microwave plasma apparatus may be about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

In some embodiments, the length of the plasma 104, which may be extended by adjusting various processing conditions and equipment configurations, may be about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

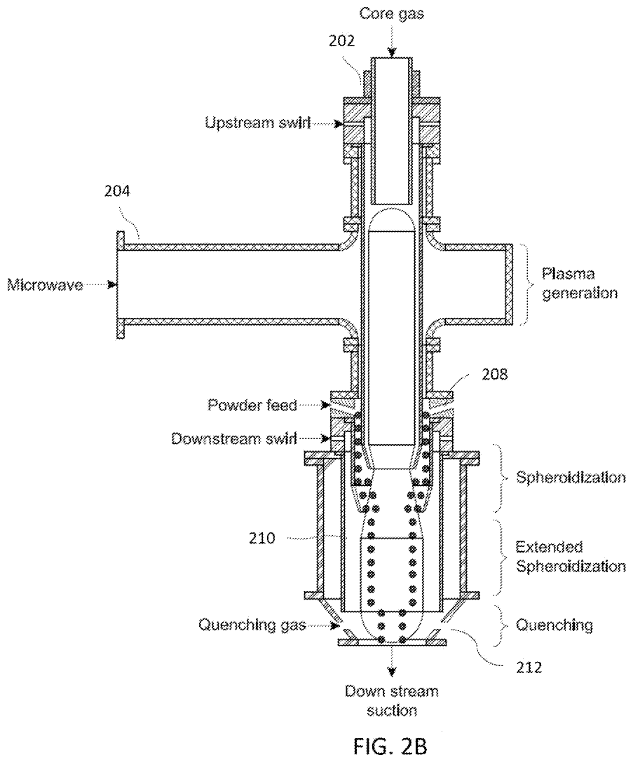

FIGS. 2A-B illustrates an exemplary microwave plasma torch that includes a side feeding hopper, thus allowing for downstream feeding. Thus, in this implementation the feedstock is injected after the microwave plasma torch applicator for processing in the “plume” or “exhaust” of the microwave plasma torch. Thus, the plasma of the microwave plasma torch is engaged at the exit end of the plasma torch to allow downstream feeding of the feedstock, as opposed to the top-feeding (or upstream feeding). This downstream feeding can advantageously extend the lifetime of the torch as the hot zone is preserved indefinitely from any material deposits on the walls of the hot zone liner. Furthermore, it allows engaging the plasma plume downstream at temperature suitable for optimal melting of powders through precise targeting of temperature level and residence time. For example, there is the ability to dial the length of the plume using microwave powder, gas flows, and pressure in the quenching vessel that contains the plasma plume.

Generally, the downstream feeding can utilize two main hardware configurations to establish a stable plasma plume which are: annular torch, such as described in U.S. Pat. Pub. No. 2018/0297122, the entirety of which is hereby incorporated by reference, or swirl torches described in U.S. Pat. No. 8,748,785 B2 and U.S. Pat. No. 9,932,673 B2, the entireties of which are hereby incorporated by reference. A feed system close-coupled with the plasma plume at the exit of the plasma torch is used to feed powder axisymmetrically to preserve process homogeneity.

Other feeding configurations may include one or several individual feeding nozzles surrounding the plasma plume. The feedstock powder can enter the plasma at a point from any direction and can be fed in from any direction, 360° around the plasma, into the point within the plasma. The feedstock powder can enter the plasma at a specific position along the length of the plasma plume where a specific temperature has been measured and a residence time estimated for sufficient melting of the particles. The melted particles exit the plasma into a sealed chamber where they are quenched then collected.

The feed materials 214 can be introduced into a microwave plasma applicator 202. A hopper 206 can be used to store the feed material 214 before feeding the feed material 214 into the microwave plasma applicator 202, plume and/or exhaust 218. The feed material 214 can be injected at any angle relative to the longitudinal direction of the plasma applicator 302, wherein the angle is about 5, 10, 15, 20, 25, 30, 35, 40, 45, 50, or 55 degrees. In some embodiments, the feedstock can be injected an angle of greater than 5, 10, 15, 20, 25, 30, 35, 40, 45, 50, or 55 degrees. In some embodiments, the feedstock can be injected an angle of less than 5, 10, 15, 20, 25, 30, 35, 40, 45, 50, or 55 degrees. In alternative embodiments, the feedstock can be injected along the longitudinal axis of the plasma torch.

The microwave radiation can be brought into the plasma applicator 202 through a waveguide 204. The feed material 214 is fed into a plasma chamber 210 and is placed into contact with the plasma generated by the plasma applicator 202. When in contact with the plasma, plasma plume, or plasma exhaust 218, the feed material melts. While still in the plasma chamber 210, the feed material 214 cools and solidifies before being collected into a container 212. Alternatively, the feed material 214 can exit the plasma chamber 210 through the outlet 212 while still in a melted phase and cool and solidify outside the plasma chamber. In some embodiments, a quenching chamber may be used, which may or may not use positive pressure. While described separately from FIG. 1, the embodiments of FIGS. 2A and 2B are understood to use similar features and conditions to the embodiment of FIG. 1.

### Multiple Microwave Plasma Applicator Geometries

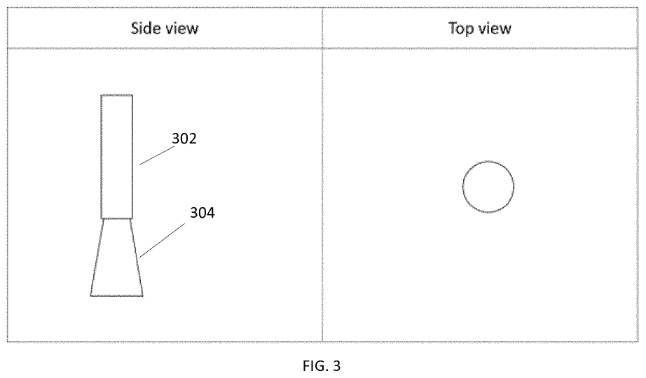

FIG. 3 illustrates an embodiment of a single microwave plasma applicator geometry that can be used in a microwave plasma torch. In a single microwave plasma applicator torch, a single applicator 302 generates a microwave plasma 304. The single plasma applicator system as shown in FIG. 3 is a schematic representation of the applicator systems of FIG. 1-2B.

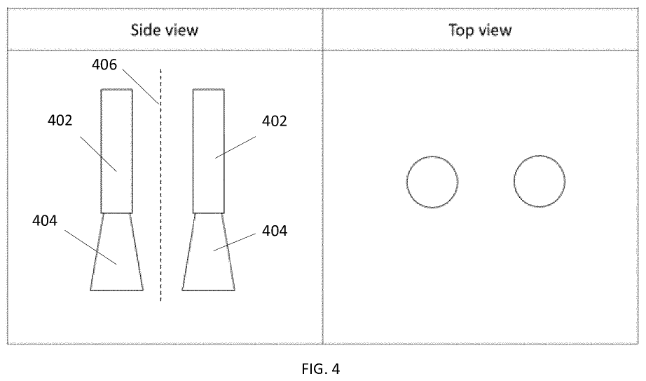

FIG. 4 illustrates an embodiment of a multiple plasma applicator system. In some embodiments, a multiple applicator plasma system consists of two microwave applicators 402. Microwave plasma applicators 402 are configured to be able to generate microwave plasmas 404, as discussed above. In some embodiments with two microwave plasma applicators 402, each microwave plasma applicator is aligned relative to a central axis 406. In some embodiments, the microwave plasma applicators 402 are planarly disposed to one another and are substantially parallel to the central axis 406.

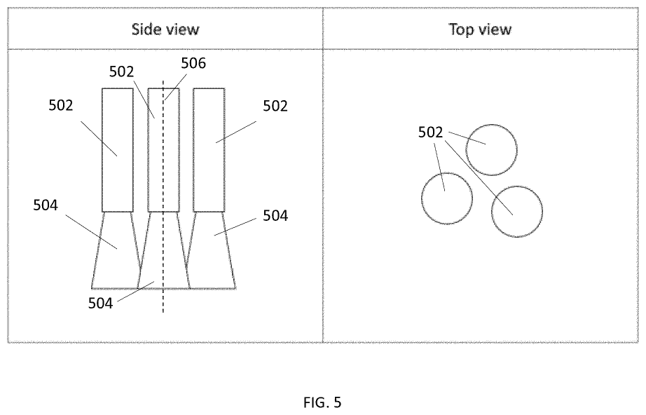

FIG. 5 illustrates an embodiment of a multiple plasma applicator system. In some embodiments, a multiple plasma applicator system can consist of three microwave plasma applicators 502. In some embodiments, each microwave plasma applicator 502 can be configured to produce a microwave plasma plume 504. In some embodiments, each microwave plasma plume 504 converges to form a combined plasma at or near central axis 506. In some embodiments, each microwave plasma plume 504 does not converge or overlap, but instead each generated microwave plasma plume 504 is parallel to each other generated microwave plasma plume 504. In some embodiments, the three microwave plasma applicators 502 are arranged around a central axis 506. In some embodiments, each microwave plasma applicator 502 is planarly disposed relative to the other microwave plasma applicators 502.

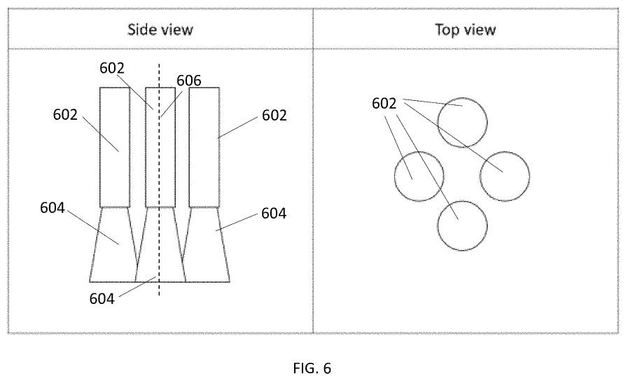

FIG. 6 illustrates an embodiment of a multiple microwave plasma applicator system. In some embodiments, a multiple plasma applicator system can consist of four microwave plasma applicators 602. In some embodiments, each microwave plasma applicator 602 can be configured to produce a microwave plasma plume 604. In some embodiments, each microwave plasma plume 604 converges to form a combined plasma. In some embodiments, each microwave plasma plume 604 does not converge or overlap, but instead each generated microwave plasma plume is parallel to each other generated microwave plasma plume. In some embodiments, each of the four microwave plasma applicators 602 are arranged around a central axis 606. In some embodiments, the each of the microwave plasma applicators 602 are parallel to the central axis 606.

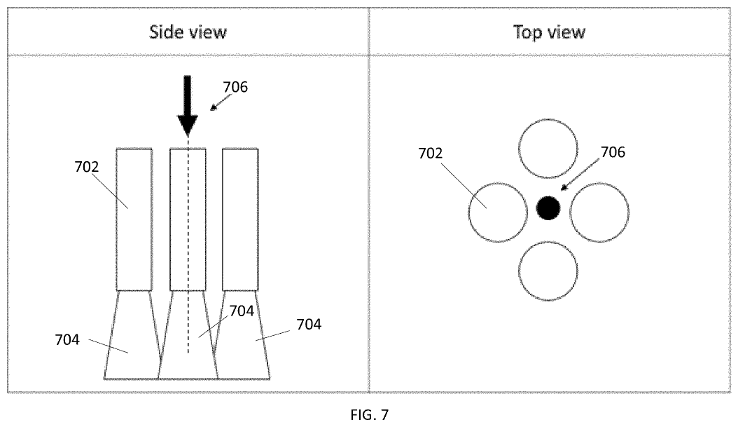

FIG. 7 illustrates an embodiment of a multiple plasma applicator system. In some embodiments, a multiple plasma applicator system can consist of four microwave plasma applicators 702. In some embodiments, each microwave plasma applicator 702 can be configured to produce a microwave plasma plume 704. In some embodiments, a feed material 706 can be directed or fed between the applicators 702. In some embodiments, a feed material 706 is introduced from above the microwave plasma applicators. In other embodiments, a feed material 706 is introduced from a horizontal direction relative to the microwave plasma applicators 702.

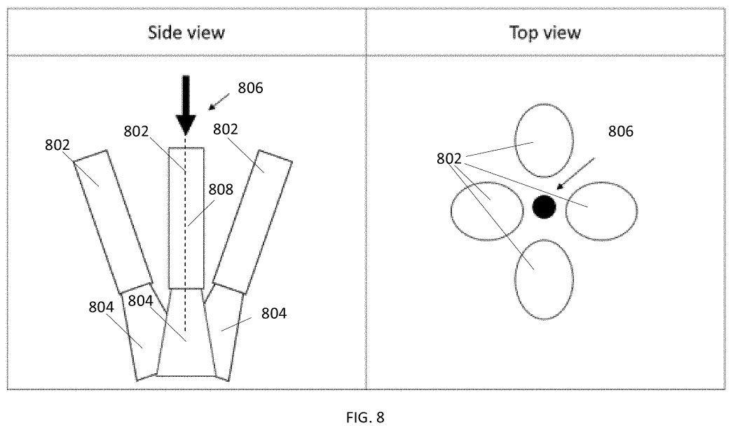

FIG. 8 illustrates an embodiment of a multiple plasma applicator system. In some embodiments, a multiple plasma applicator system can consist of four microwave plasma applicators 802. In some embodiments, each microwave plasma applicator 802 can be configured to produce a microwave plasma plume 804. In some embodiments each microwave plasma applicator is arranged around a central axis 808. Microwave plasma applicators 802 can be tilted towards the central axis. As described above, each microwave plasma applicator 802 can be tilted towards or away from the central axis 808 forming an angle between the microwave plasma applicator 802 and the central axis 808. In some embodiments, the angle between each microwave plasma applicator 802 and the central axis 808 can be between 0°-90°. In some embodiments, tilting the microwave plasma applicators 802 towards the central axis 808 can cause the plasma exhausts/plumes 804 to converge at or near central axis 808. In some embodiments, a feed material 806 can be directed or fed between the applicators 802. In some embodiments, a feed material 806 is introduced from above the microwave plasma applicators. In other embodiments, a feed material 806 is introduced from a horizontal direction relative to the microwave plasma applicators 802. In some embodiments, when the feed material 806 is introduced between the plasma applicators 802, the feed material comes into contact with each of the plasma plumes 804. In some embodiments, the tilting of the plasma applicators 802 can cause the plasma plumes 804 to converge and form a combined plasma. In some embodiments, introducing the feed material 806 in between the plasma applicators 802 can cause the feed material 806 to contact the combined plasma.

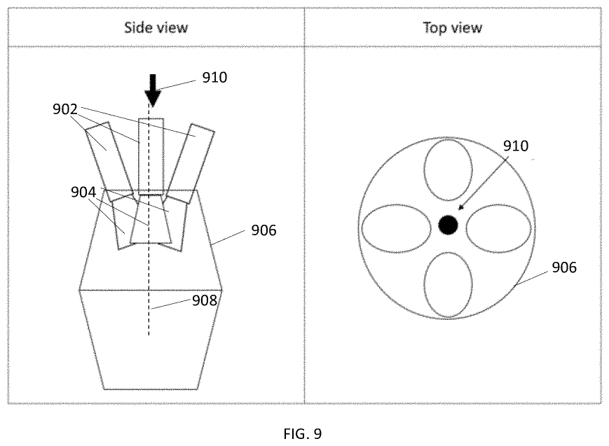

FIG. 9 illustrates an embodiment of a multiple plasma applicator system. In some embodiments, a multiple plasma applicator system can consist of four microwave plasma applicators 902. In some embodiments, each microwave plasma applicator 902 can be configured to produce a microwave plasma plume 904. In some embodiments each microwave plasma applicator 902 is arranged around a central axis 908. Microwave plasma applicators 902 can be tilted towards the central axis 908. As described above, each microwave plasma applicator 902 can be tilted towards or away from the central axis 908 forming an angle between the microwave plasma applicator 902 and the central axis 908. In some embodiments, the angle between each microwave plasma applicator 902 and the central axis 908 can be between 0°-90°. In some embodiments, tilting the microwave plasma applicators 902 towards the central axis 908 can cause the plasma exhausts/plumes 904 to converge. In some embodiments, a feed material 910 can be directed or fed between the applicators 902. In some embodiments, a feed material 910 is introduced from above the microwave plasma applicators. In other embodiments, a feed material 910 is introduced from a horizontal direction relative to the microwave plasma applicators 902. In some embodiments, when the feed material 910 is introduced between the plasma applicators 902, the feed material comes into contact with each of the plasma plumes 904. In some embodiments, the tilting of the plasma applicators 902 can cause the plasma plumes 904 to converge and form a combined plasma. In some embodiments, introducing the feed material 910 in between the plasma applicators 902 can cause the feed material 910 to contact the combined plasma.

In some embodiments an extension tube 906 may extend into the reaction chamber and surround and guide the plasma exhaust and/or exhausts 904. In some embodiments, an extension tube can be used with a single microwave plasma applicator and one microwave plasma. In some embodiments, an extension tube can be used with multiple microwave plasma applicators and one or more microwave plasmas. In some embodiments, extension tube 906, which extends downward from the microwave plasma applicators 902 into the reaction chamber. In some embodiments, the extension tube 906 may concentrate energy from the microwave power source into a smaller volume, extending and directing the plasmas at a greater length than would be possible using a conventional microwave plasma apparatus. In some embodiments, a length of the plasmas may be tuned or altered by configuring one or more of the following parameters: power, plasma gas flow, type of gas, extension tube material, level of insulation of the reactor chamber or the extension tube, level of coating of extension tube, and geometry of the extension tube (e.g., tapered/stepped).

In some embodiments, the extension tube 906 may comprise a stepped shape, such that the tube comprises one or more cylindrical volumes extending downward in the reaction chamber, wherein each successive cylindrical volume comprises a larger diameter than each previous cylindrical volume as the tube extends downward in the reaction chamber. In some embodiments, the extension tube 910 may have a conical shape, tapering radially outwards as it extends downward into the reaction chamber. In some embodiments, the extension tube 910 may have a dual conical shape, where the first conical shape tapers radially outwards as it extends downward into the reaction chamber and the second conical shape is an inverted symmetrical shape to the first conical shape and is connected to the end of the first conical shape and tapers radially inwards as it extends downward into the reaction chamber, as shown in FIG. 9. In some embodiments, the extension tube 910 may comprise a single cylindrical volume. In some embodiments, feed material inlets may insert feedstock within the extension tube 906.

In some embodiments, the extension tube may comprise a length of about 1 foot. In some embodiments, the extension tube may comprise a length of about 1 inch, about 2 inches, about 3 inches, about 4 inches, about 5 inches, about 6 inches, about 7 inches, about 8 inches, about 9 inches, about 10 inches, about 11 inches, about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

In some embodiments, the feedstock particles are exposed to a temperature profile between 4,000 and 8,000 K within the microwave plasma. In some embodiments, the particles are exposed to a temperature profile between 3,000 and 8,000 K within the microwave plasmas. In some embodiments, one or more temperature sensors may be located within the microwave plasma torch to determine a temperature profile of multiple plasmas.

### Microwave Plasma Processing

In a microwave plasma process, the feedstock may be entrained in an inert and/or reducing gas environment and injected into the microwave plasma, the microwave plasma plume, or the microwave plasma exhaust. Upon injection into a hot plasma (or plasma plume or exhaust), the feedstock may undergo a physical and/or chemical transformation (e.g., spheroidization). After processing, the resulting material may be released into a chamber filled with an inert gas and directed into hermetically sealed drums where is it stored. This process can be carried out at atmospheric pressure, in a partial vacuum, or at a slightly higher pressure than atmospheric pressure.

In alternative embodiments, the process can be carried out in a low, medium, or high vacuum environment. The process can run in batches or continuously, with the drums being replaced as they fill up with processed material. By controlling the process parameters, such as cooling gas flow rate, residence time, plasma conditions, cooling gas composition, various material characteristics can be controlled.

Residence time of the particles within a hot zone of the plasma can also be adjusted to provide control over the resulting material characteristics. That is, the length of time the particles are exposed to the plasma determines the extent of melting of the feedstock particles (i.e., surface of the particle melted as compared to the inner most portion or core of the particle). Residence time can be adjusted by adjusting such operating variables of particle injection rate and flow rate (and conditions, such as laminar flow or turbulent flow) within the hot zone. Equipment changes can also be used to adjust residence time. For example, residence time can be adjusted by changing the cross-sectional area of the plasma, by, for example, extending the plasma. In some embodiments, extending the plasma may comprise incorporating an extension tube into the microwave plasma apparatus.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A microwave plasma apparatus for processing a material, the microwave plasma apparatus comprising:
a reaction chamber;
a plurality of microwave plasma applicators in communication with the reaction chamber;
at least one microwave radiation source for generating microwave radiation;
at least one waveguide configured to direct the microwave radiation from the at least one microwave radiation source to the plurality of microwave plasma applicators; and
a material feeding system in communication with the reaction chamber.

2. The microwave plasma apparatus of claim 1, wherein each microwave plasma applicator of the plurality of microwave plasma applicators is configured to generate a plasma plume.

3. The microwave plasma apparatus of claim 2, wherein the plurality of microwave plasma applicators are arranged such that the plasma plume generated by each microwave plasma applicator does not converge.

4. The microwave plasma apparatus of claim 2, wherein the plurality of microwave plasma applicators are arranged such that the plasma plume generated by each microwave plasma applicator converges to form a combined plasma plume.

5. The microwave plasma apparatus of claim 2, wherein each of the plurality of microwave plasma applicators is oriented substantially parallel to a central axis.

6. The microwave plasma apparatus of claim 2, wherein:
each of the plurality of microwave plasma applicators are angled towards a central axis; and
an angle between each of the plurality of microwave plasma applicators and the central axis is between about 0° and about 90°.

7. The microwave plasma apparatus of claim 1, further comprising at least one gas supply system in communication with at least one microwave plasma applicator of the plurality of microwave plasma applicators.

8. The microwave plasma apparatus of claim 7, wherein the at least one microwave plasma applicator is configured to generate at least one plasma plume when a gas is introduced to the at least one microwave plasma applicator from the at least one gas supply system.

9. The microwave plasma apparatus of claim 1, wherein the microwave plasma apparatus comprises the same number of microwave radiation sources and the same number of waveguides as the number of microwave plasma applicators.

10. The microwave plasma apparatus of claim 1, wherein the microwave plasma apparatus comprises half the number of microwave radiation sources as the number of microwave plasma applicators.

11. The microwave plasma apparatus of claim 1, wherein the microwave plasma apparatus comprises half the number of waveguides as the number of microwave plasma applicators.

12. The microwave plasma apparatus of claim 1, wherein the plurality of microwave plasma applicators comprises 2, 3, or 4 microwave plasma applicators.

13. The microwave plasma apparatus of claim 12, wherein each of the 2, 3, or 4 microwave plasma applicators is planarly disposed relative to at least one other microwave plasma applicator at an angle of about 90°, about 120°, or about 180°.

14. The microwave plasma apparatus of claim 1, wherein the plurality of microwave plasma applicators are arranged in a planar geometry relative to one another.

15. The microwave plasma apparatus of claim 1, wherein the plurality of microwave plasma applicators consists of 2 microwave plasma applicators.

16. The microwave plasma apparatus of claim 1, wherein the plurality of microwave plasma applicators consists of 4 microwave plasma applicators.

17. The microwave plasma apparatus of claim 16, wherein each of the four microwave plasma applicators is planarly disposed relative to at least one other microwave plasma applicator of the plurality of microwave plasma applicators at an angle of 90°.

18. The microwave plasma apparatus of claim 1, wherein the material feeding system is configured to feed a process material between the plurality of microwave plasma applicators.

19. The microwave plasma apparatus of claim 1, wherein:
the reaction chamber includes an outlet; and
the material feeding system is configured to direct a process material to the reaction chamber from a horizontal direction below the outlet.

20. The microwave plasma apparatus of claim 1, further comprising an extension tube within the reaction chamber configured to confine a plasma generated by each of the plurality of microwave plasma applicators.
